(19) United States
(12) Patent Application Publication
(10) Pub. No.: US 2011/0313726 A1
(43) Pub. Date: Dec. 22, 2011

(54) CONDITION-BASED MAINTENANCE SYSTEM FOR WIND TURBINES

(75) Inventors: Girija Parthasarathy, Maple Grove, MN (US); Onder Uluyol, Fridley, MN (US); Wendy Foslien, Woodbury, MN (US)

(73) Assignee: HONEYWELL INTERNATIONAL INC., Morristown, NJ (US)

(21) Appl. No.: 12/718,878

(22) Filed: Mar. 5, 2010

Related U.S. Application Data
(60) Provisional application No. 61/157,861, filed on Mar. 5, 2009.

(51) Int. Cl. G06F 15/00; G06F 17/18

(52) U.S. Cl. 702/179; 702/184

(57) ABSTRACT

A condition-based maintenance system having instrumentation for collecting data from one or more wind turbines and having a performance monitor for analyzing the data. Also, the system may have a wind turbine anomaly detector. Information from the performance monitor and the anomaly detector may be used for indicating conditions of the one or more wind turbines. These conditions may be a basis for determining maintenance recommended for any of the wind turbines.

This application claims the benefit of U.S. Provisional Application Ser. No. 61/157,861, filed Mar. 5, 2009, and entitled “Anomaly Detection across Multiple Wind Turbines in a Wind Farm”. U.S. Provisional Application Ser. No. 61/157,861, filed Mar. 5, 2009, is hereby incorporated by reference.

### BACKGROUND

The invention pertains to system maintenance schemes and particularly as it relates to data of a system. More particularly, the invention pertains to wind turbines and like systems.

### SUMMARY

The invention is a condition-based maintenance system having instrumentation for collecting data from one or more wind turbines and having a performance monitor for analyzing the data. Also, the system may have a wind turbine anomaly detector. Information from the performance monitor and the anomaly detector may be used for indicating conditions of the one or more wind turbines. These conditions may be a basis for determining maintenance recommended for any of the wind turbines.

### BRIEF DESCRIPTION OF THE DRAWING

FIG. 1 is a diagram of technology for condition-based monitoring of wind turbines;

FIG. 2 is a diagram of a wind turbine health monitoring system;

FIGS. 3a and 3b are diagrams of example screens for a ground based station;

FIG. 4 is a diagram of a sample engineering display showing aircraft engine performance overlaid with detected flight regimes;

FIG. 5 is a diagram of an illustrative system for data based performance monitoring and anomaly detection;

FIG. 6 is a diagram of elements of an illustrative performance monitoring system;

FIG. 7 is a diagram showing performance parameters as deviations from an expected output for a wind turbine;

FIG. 8 is a diagram of an application of self organizing feature maps; and

FIG. 9 is a diagram of an auto associative neural network as applied to wind turbines.

### DESCRIPTION

Wind turbines may often operate in severe, remote environments and require frequent scheduled maintenance. The term “wind turbine” may generally include the generator, gearbox, shaft, nacelle, and other intrinsic components, unless indicated or implied otherwise herein. The cost of unscheduled maintenance due to undetected failures may be high both in maintenance support and lost production time. Condition-based maintenance (CBM) rather than hours-based maintenance (HBM) may enable higher reliability and lower maintenance costs by eliminating unnecessary scheduled maintenance.

Condition-based maintenance (CBM) may use many techniques, one of them being performance monitoring. Performance monitoring may be a way of tracking the performance of a wind turbine by, for example, comparing actual performance parameters against expected ones, and detecting anomalies by deviation measures. Under some conditions, however, anomaly detection by checking sensor readings of individual wind turbines may classify certain extreme, but normal, operating conditions as faulty.

Conditions may be a basis for determining whether maintenance is recommended for one or more wind turbines. The conditions may be classified as normal, anomalous, excessive, deficient, or unclassified, relative to expected conditions of the one or more wind turbines, or their components.

Individual wind turbines of a wind farm may typically experience similar environmental conditions (e.g., wind patterns and gusts). While each individual wind turbine may experience locally different operating and/or environmental conditions from another wind turbine in the same wind farm, data from all or some sub-set of wind turbines of a wind farm may be used to determine normality for the group as well as failures that manifest themselves under certain conditions. These norms and failures may be thought of as an orthogonal set of data which is rich in information that can be utilized for better prediction accuracy of faults, with lower false positives. Comparing the performance parameters of a set of wind turbines in the same region may provide insights that help prevent unnecessary alarms, while confirming actual faults.

In one illustrative approach, a principal components analysis (PCA) may be used to analyze data for each wind turbine. Such PCA analysis may be used to detect an anomaly in the wind turbine. Alternatively, or in addition, PCA analysis and/or other collected data from each of multiple wind turbines may be employed to help provide better anomaly prediction of faults in the wind turbines, with lower false positives. In some cases, simple scatter plot(s) and/or statistical threshold(s) may be used for comparison across wind turbines. An associative model that maps a correlation between the performance parameters of the wind turbines in a region may be provided. An anomaly may be detected if there is a break in the expected correlation, as actual performance parameters deviate from the associative model estimate.

A system may be deployed at a wind turbine site, or remotely, as part of a controller or as part of a HUMS (health and usage monitoring system). As actual operating data of the wind turbine come in to the system, the system may calculate performance parameters and/or principal components analysis (PCA) statistics for each turbine. An associative model and statistical methods may be used to process this data to automatically detect an anomaly. The results may be reported up through a corresponding condition-based maintenance (CBM) system.

Condition-based maintenance and performance monitoring may have a much broader potential for an operator/owner benefit than just basic monitoring for mechanical failures. Data may be gathered for the top failure modes of wind turbines, as well as data from a wind turbine SCADA (supervisory control and data acquisition system) feeds (and sometimes from multiple wind turbines within a wind farm). The data may include but are not limited to: 1) Performance monitoring - - - using statistical techniques to monitor rotor performance given wind speeds by comparing actual versus expected - - - generator power produced may be monitored in the same way; 2) Anomaly detection for a wind turbine population - - - the wind turbines in a wind farm do not experience identical conditions, but during normal operation, have a certain correlation with each other - - - an evolving fault in one wind turbine can show up as an outlier in the population data, flagging a possible fault; (3) Start-stop data feature extraction - - - wind turbines may operate between a cut-in and cut-out wind speed - - - the transients during this start and stop may provide information that results in a powerful way to analyze mechanical fault evolution (e.g., bearing failures) and also faults that manifest during these periods; (4) Generator fault detection - - - analytics based on electrical characteristics to detect generator electrical or mechanical faults may be used; and (5) Structural life usage monitoring - - - fatigue life limited rotating components can benefit from usage monitoring of the stress cycles - - - from this (and other) data, diagnostic and prognostic analytics may be developed and tuned.

In general, a condition based maintenance (CBM) system for equipment or processes should account for health monitoring of: 1) The performance degradation of the core process; 2) Mechanical system faults (such as bearings, shafts and gears); 3) Electrical system faults (such as power electronics, generator faults); and/or 4) Material or structural faults (such as fatigue cracks and corrosion). Development of HUMS-based vibration monitoring may target mechanical fault monitoring. The different SCADA data-based CBM approaches may target performance monitoring. By targeting the critical health monitoring needs of a wind farm operator, a cost-effective solution to the difficult maintenance challenges may be provided. In some cases, an existing infrastructure of a company's health and usage monitoring system (HUMS) may be used for integration of a condition based maintenance (CBM) system for wind farms.

A company's CBM project approach may include the following points and benefits. The CBM project may have proven cutting edge technologies (i.e., HUMS, turbine engine health, and process health monitoring). These technologies may result in rapid development and deployment. The approach of a project may be comprehensive with accurate fault prediction and maintenance cost reduction, and flexibility to add analytics. There may be HUMS vibration monitoring with rapid deployment using highly configurable hardware and software. SCADA based analytics may be implemented utilizing a rich source of available data with only a software solution with no need for hardware. The application of the project on a working wind turbine should result in a rapid productization.

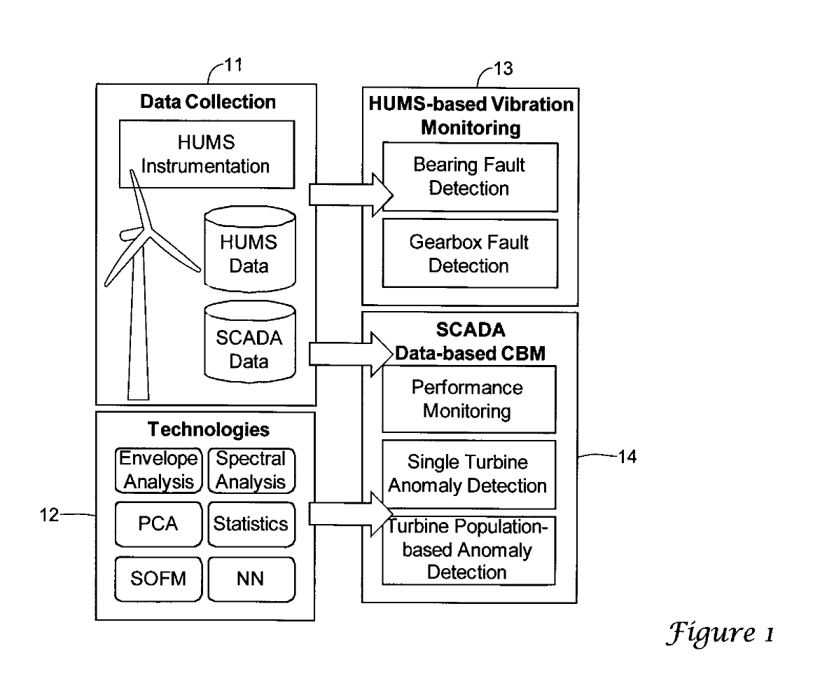

FIG. 1 is a diagram of technology for condition based monitoring of wind farms. The system may have data collection 11, technologies 12, HUMS-based vibration monitoring 13, and SCADA data-based CBM 14. Data collection 11 may incorporate HUMS instrumentation, and HUMS and SCADA data. Technologies 12 may include envelope analysis, spectral analysis, PCA, statistics, SOFM (self-organizing feature map) and NN (a neural network). HUMS-based vibration monitoring 13 may incorporate bearing fault detection and gearbox fault detection. The SCADA data-based CBM 14 may incorporate performance monitoring, single turbine anomaly detection, and turbine population-based anomaly detection.

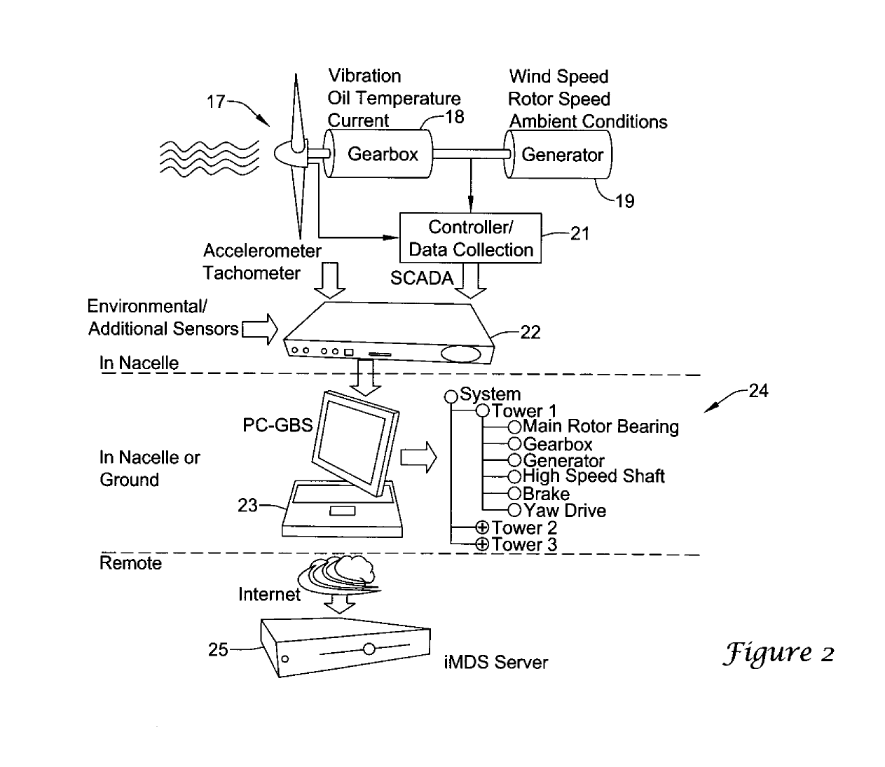

FIG. 2 is a diagram of a wind turbine health monitoring system. It may show illustrative technology map for the wind turbine CBM system. Two main CBM elements of a combined HUMS based mechanical fault monitoring and SCADA data based performance monitoring system for wind farms are noted herein. Mechanical fault monitoring may use a health and usage monitoring system. A diagram of a wind turbine CBM system is shown. The system may include vibration and speed sensors, and rack-mounted equipment for on-site data collection and processing (the Honeywell Zing™ HUMS). This system has historically been used for helicopter HUMS. A computer that runs the PC-GBS (PC-ground based station) software may be used by the maintainer for download, summary display, and recommendation of action items. Data collected by PC-GBS systems may be seamlessly downloaded to an intelligent machinery diagnostic system (iMDS) server for archive and analysis. The entire system may be configured using a software tool called the iMDS™ (intelligent machinery diagnostic system) database setup tool.

Each component in the system of FIG. 2 may leverage or be part of the health and usage monitoring system (HUMS) technology developed for health monitoring of military and commercial helicopters. That system also appears to have demonstrated quantifiable results for reducing, even eliminating, required scheduled maintenance, identifying faults that would not have been detected under existing maintenance procedures, and reducing unscheduled component removal/replacement. This system appears to have reduced unscheduled maintenance, maintenance personnel time, costly downtime, and costly replacement of components.

The system may include the “in nacelle” components shown in the Figure. The existing system components may have compatible data bases, and software agents for seamlessly transferring of data among the components to make adding a web component straight forward. Data collection and processing in the nacelle may be performed using Honeywell Zing™ HUMS. The Zing™ HUMS is rack-mounted equipment that contains the same signal processing card as in airborne data collection and processing systems, and may thus leverage the algorithms and development tools included with helicopter health monitoring equipment. If needed, a ruggedized system that has been tested for extremes in vibration and temperature may also be used.

Ground maintenance and an engineering workstation may be noted. The Zing™ HUMS may be coupled with a PC-ground based station (PC-GBS). The PC-GBS may store data received from the wind turbines, analyze the data to determine if limits have been exceeded, annunciate anomalies and/or faults, and/or specify corrective maintenance actions.

In FIG. 2, the system may have a wind blade 17 which turns an input shaft to a gearbox 18. An output shaft from gearbox 18 may be connected to an input shaft of a generator 19. Sensors proximate to or on the gearbox 18 and generator 19 may provide signals to a controller/data collection module 21. The sensors may cover vibration, oil temperature, current, wind speed, rotor speed and ambient conditions. Other parameters may be sensed, such as acceleration, environmental and others. These parameters and SCADA from module 21 may go to a ground maintenance and engineering workstation 22. Workstation 22 (in a nacelle) may be coupled (with outputs) to a PC-based ground station (e.g., PC-GBS) 23 (in the nacelle or the ground). A display of station 23 may show a screen 24 showing such things as a system having a tower 1 with a main rotor bearing, gearbox, generator, high speed shaft, brake and yaw, plus towers 2 and 3, as additional examples. An output of station 23 may go to a remote station 25, such as for example a Zing™ Ware 1034™ iMDS server.

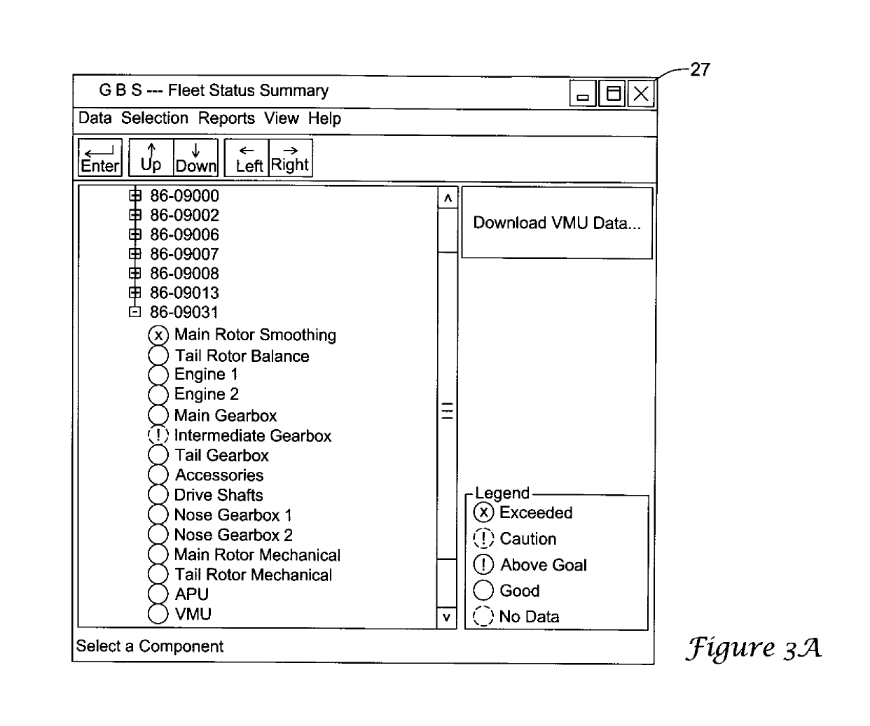

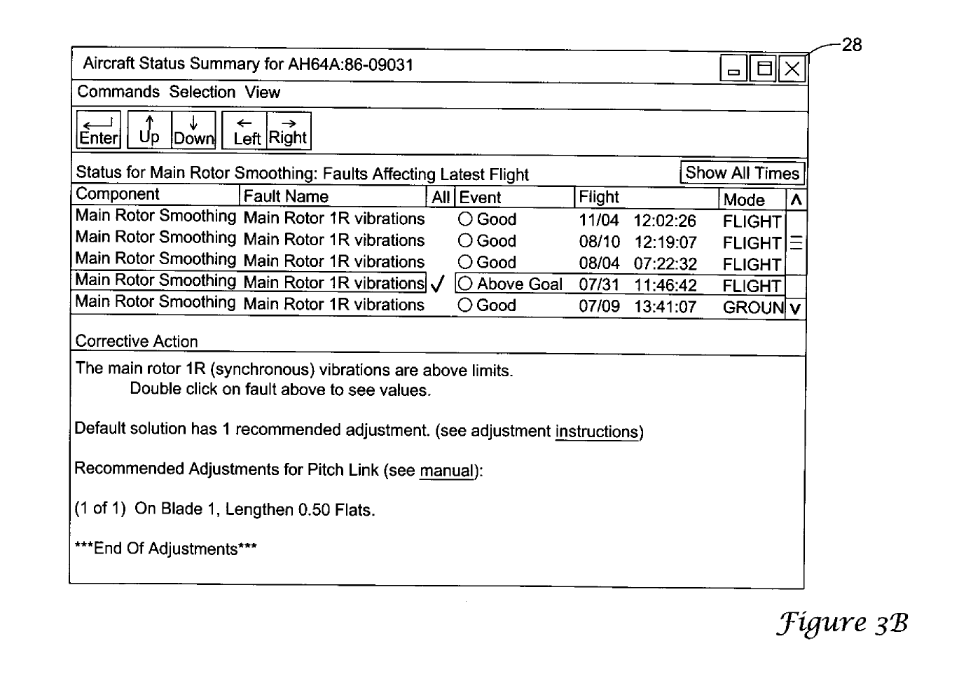

FIGS. 3a and 3b are diagrams of example screens 27 and 28 for a ground based station. These Figures are diagrams of a main user interface for the PC-GBS for a company's helicopter system. It shows a summary display, a maintenance screen, and a maintenance manual display. The display of aircraft type, tail number and component may be based on a familiar file tree structure common in Microsoft Windows applications. Equipment and component health may be indicated with colored icons as red, yellow, or green status. A similar display may be used for displaying performance and/or maintenance information regarding wind turbines.

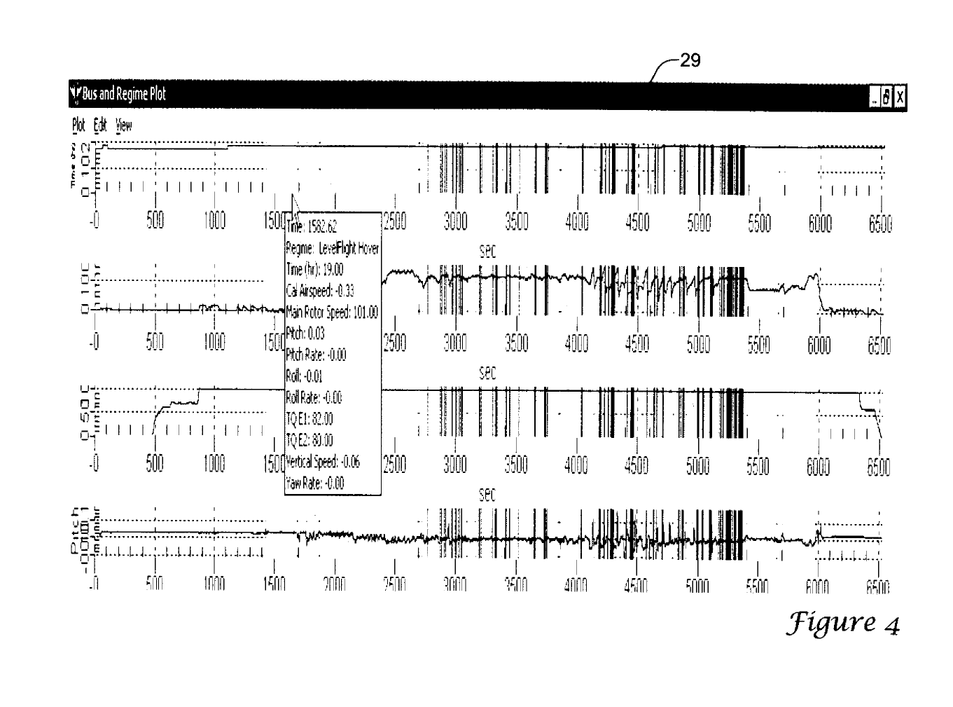

The illustrative PC-GBS may also include tools to allow the user to easily drill down from the summary displays to pull out and analyze raw spectra and raw data collected by the system. FIG. 4 shows an example display that brings together a variety of information. The Figure reveals a screen 29 showing performance data. It shows a diagram of a sample engineering display showing aircraft engine performance overlaid with detected flight regimes.

A database setup tool may be noted. A feature that may set a company's mechanical monitoring apart from all competitors may be the ease of configuring the system for any rotating machinery application. Configuration of both the Zing™ HUMS system and the PC-GBS may be controlled using a software product referred to as a database setup tool. Database setup tables may provide complete control over the measurement and diagnostic processing necessary for HUMS algorithms. The HUMS diagnostic products may be configurable for application to new sensors, new algorithms, and new equipment types and components by changing database setup tables. The system may incorporate not only processing of vibration related data, but also have the ability to input bus data such as the SCADA bus, which can enable use of this architecture in wind turbine CBM integration.

Vibration monitoring algorithms may be noted. Vibration measurement and diagnostic processing may be used to provide component-specific diagnostics that provide robust indicators of a mechanical fault in a wind turbine. To develop robust indicators, factors such as sensor location and type, measurement, diagnostic processing and limits setting may be used.

The objective of vibration measurement and diagnostic processing is to develop component-specific diagnostics that provide robust indicators of mechanical faults. To develop robust indicators, factors such as sensor location and type, measurement, diagnostic processing, and limits setting may be taken into account. The data collection hardware may also embed sophisticated processing capability including asynchronous time domain (ATD), synchronous time domain (STD), asynchronous frequency domain (AFD), and synchronous order domain (SOD). The accelerometer and tachometer data collected may be pre-processed with these methods. Several vibration monitoring algorithms may operate on the data structures thus produced and output condition indicators.

Typical SCADA parameters collected from commercial wind turbine systems may be noted. These parameters appear to be described as an example from “Online Wind Turbine Fault Detection through Automated SCADA Data Analysis,” by Zaher, et al., 2009. An example set of measurement, sampling rate and values for each parameter may be stated as follows: 1) Active power output - - - 10 minute-average, standard deviation; 2) Wind speed - - - 10 minute - - - average, standard deviation; 3) Nacelle temperature - - - 60 minute - - - average; 4) Gearbox bearing temperature - - - 10 minute - - - average; 5) Gearbox lubricant oil temperatures - - - 10 minute - - - average; 6) Generator winding temperature - - - 10 minute - - - average; 7) Power factor - - - 10 minute - - - average; 8) Reactive power - - - 10 minute - - - average; and 9) Phase currents - - - 10 minute - - - average. The list for a specific turbine may include additional parameters and also may have faster or slower sampling rates.

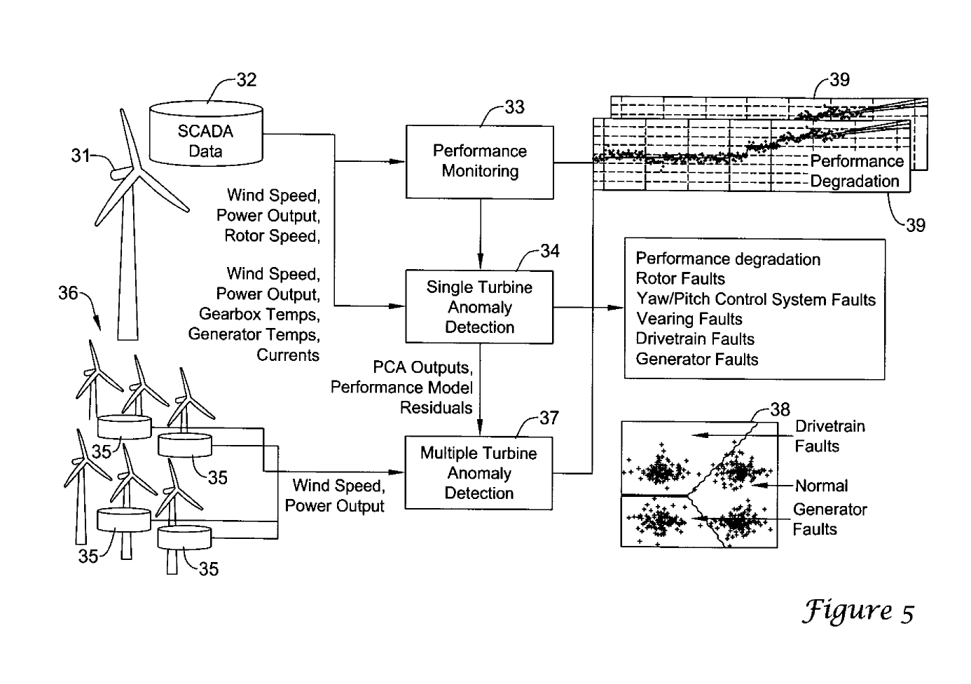

An illustrative system for SCADA data based performance monitoring and anomaly detection is shown in FIG. 5. The system may use typical SCADA parameters as noted herein and/or other parameters, as desired. The Figure shows a system having a performance monitoring layout. Wind turbine 31 may provide SCADA data 32 such as wind speed, power output, rotor speed, gearbox temperatures, generator temperatures and currents, and so on. Data 32 may go to a performance monitoring module 33 and a single turbine anomaly detection module 34. SCADA data 35, such as wind speed and power output, which come from other wind turbines 36 may go to a multiple turbine anomaly detection module 37. The single turbine anomaly detection module 34 may output information about turbine 31, such as performance degradation, rotor faults, yaw/pitch control system faults, bearing faults, drive train faults, generator faults, and so on. Drive train and generator faults and normal conditions may be plotted in a graph 38, which can be shown on a computer display.

Outputs from the performance monitoring module 33 and the multiple turbine anomaly detection module 37 may be provided as a deterioration in terms of percentage over numbers of samples in graphs 39. These results may be also regarded as indicating an amount of performance degradation.

Performance monitoring may be noted. Performance is described in the context of the underlying process physics of the equipment - - - in this case, the wind turbine. The wind turbine may convert wind kinetic energy into useful electrical energy. As the turbine components deteriorate, the efficiency with which wind energy is converted to electrical energy decreases and the performance of the turbine decreases. Performance degradation can indicate a number of problems, such as blade aerodynamic degradation due to leading and trailing edge losses, dirt or ice buildup on blades, loss due to drive train misalignment, friction caused by bearing or gear faults, generator winding faults, pitch control system degradation, as well as other issues.

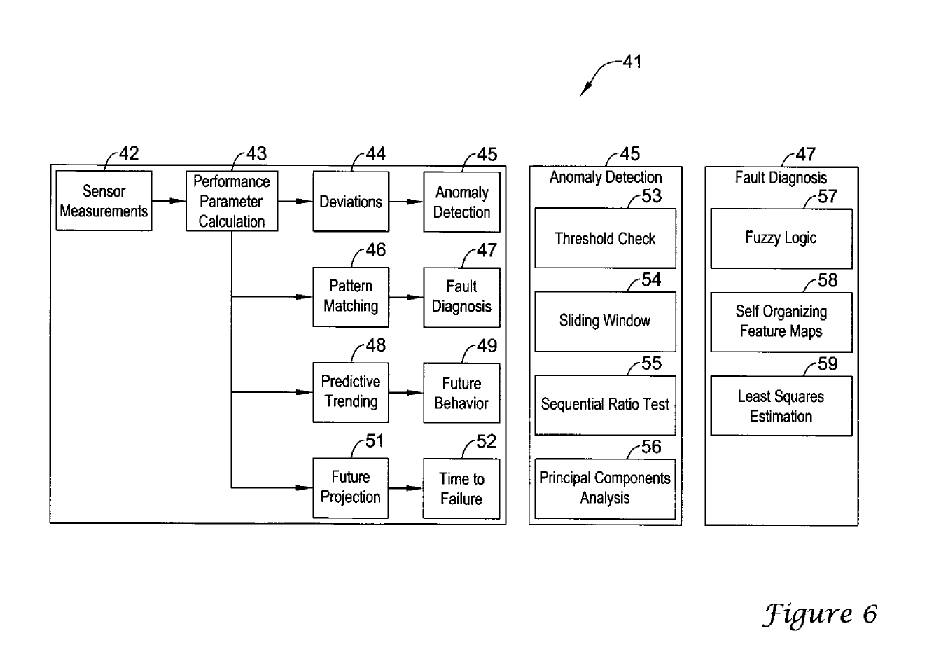

FIG. 6 describes the functional elements of an illustrative performance monitoring system, and tools for anomaly detection and fault diagnosis. It is a diagram 41 showing a basis for performance monitoring of a wind turbine power generation system. Sensor measurements 42 from the power generation systems may go to a performance parameter calculation module 43. Outputs from module 43 may incorporate deviations 44 for anomaly detection 45, pattern matching 46 for fault diagnosis 47, predictive trending 48 for future behavior 49, and future projection 51 for time to failure 52.

Anomaly detection 45 may incorporate a threshold check 53, a sliding window 54, a sequential ratio test 55 and a principal components analysis 56. Fault diagnosis 47 may incorporate fuzzy logic 57, self-organizing feature maps 58 and least squares estimation 59.

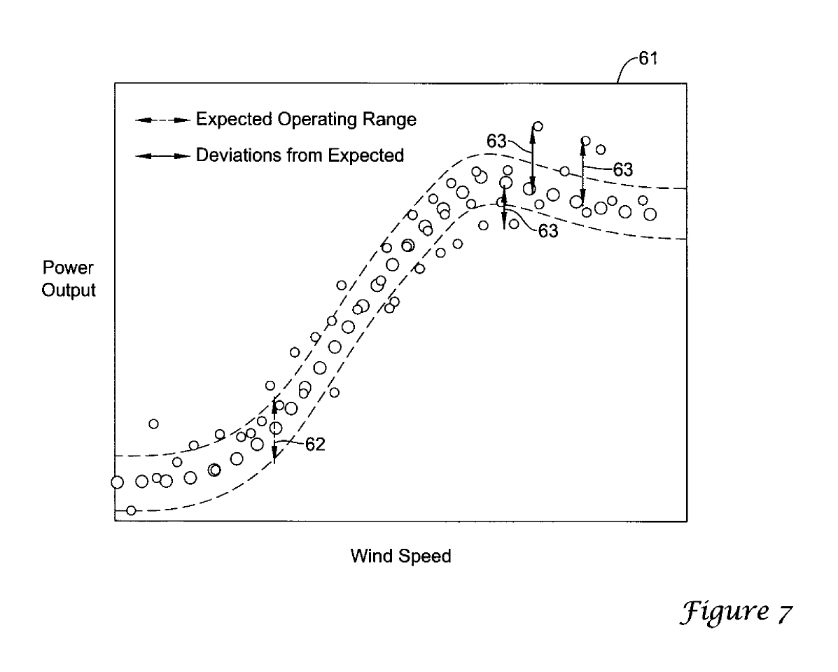

In the illustrated system, a performance parameter is first computed, based on sensor measurements. This parameter could be raw sensor values, corrected values, residuals with respect to a wind turbine model, component efficiency or aerodynamic parameters, and/or other parameters. An example of a performance parameter for a wind turbine is the difference between actual power output and expected power output based on its power curve (see, for example, FIG. 7). This parameter can then be used to test whether the wind turbine is behaving within normal bounds, or not; and this may be called anomaly detection. The anomaly may then also be classified as a particular component failure, which is known as fault diagnosis. Additional elements may involve predictive trending and prognostics, if desired.

FIG. 7 is a diagram showing performance parameters as deviations from expected output. The Figure is a graph 61 of power output versus wind speed of an example wind turbine. Symbol 62 indicates an expected operating range. Symbols 63 indicate deviations from the expected operating range.

Anomaly detection may be performed with a series of techniques that range from simple threshold checking to complex statistical analysis (FIG. 7). As illustrated in FIG. 5, and in one illustrative embodiment, two (or more) classes of anomaly and fault detection methods may be used including single turbine and multiple turbines. Both may use the same or similar underlying mathematical and statistical techniques, but the application space is different.

Single wind turbine monitoring and fault detection may refer to a set of anomaly and fault detection methods that are applied to the analysis of sensor data from individual wind turbines In some cases, principal components analysis (PCA) and self organizing feature maps may be used as the underlying techniques for this purpose.

Anomaly detection method may be effected via a principal component analysis. Multivariate statistics may be applied to complex processes to provide a better indication of problems than univariate statistics. One approach to detecting changes in process performance is to use principal components analysis and partial least squares (PLS) regression. PCA and PLS are established methods that can be used to manage highly correlated process variables.

Using PCA, the analysis of a large number of process variables from an area or sub-process may be reduced to a subset of linear combinations. These linear combinations of process variables can be referred to as latent variables. The original inputs can be thought of as projecting to a subspace by means of a particular transformation. Unlike the raw inputs, the latent variables are guaranteed to be independent. The plane of normal operation establishes a benchmark from which to judge future process states. Confidence limits may be established around this plane or model to determine the boundaries of the subspace. Fault detection or process monitoring may be done by periodically taking new values of the input variables that represent a new process condition or state. Early detection of changes in the process can be detected as the statistics cross the boundaries of the plane.

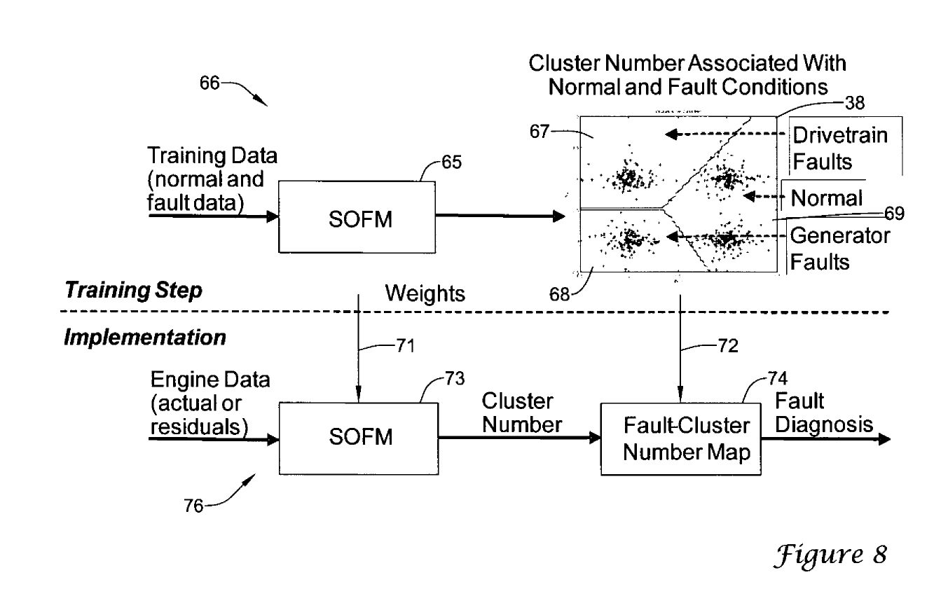

Anomaly detection method may be done via self-organizing feature maps (SOFMs). Clustering algorithms are methods that divide a set of n observations into g groups so that members of the same group or cluster are more alike than members of different groups. The self-organizing feature map (SOFM) is a type of unsupervised clustering algorithm, forming neurons located on a regular grid, usually of 1- or 2-dimensions. The cluster representatives that are the neurons in the layer of a SOFM are initially assigned at random in some suitable distribution according to a topology function, which dictates the structure of the map. SOFMs can detect regularities and correlations in their input and adapt their future responses to that input by learning to classify input vectors. Based on the competitive learning process, the neurons may become selectively tuned to input patterns so that neurons physically near each other in the neuron layer respond to similar input vectors. Since the health condition (normality or failure) for each data point is not available in the field, the SOFM is particularly suited to finding patterns in the data and without target class labels. This is shown in FIG. 8.

Fault diagnosis may be done using self organizing feature maps (SOFMs). FIG. 8 shows an application of self organizing feature maps. Training data (normal and fault data) may be provided to a SOFM module 65 in training step 66. Module 65 may output a graph 38 of data with a cluster number associated with normal and fault conditions. The clusters may be in groups indicating drive train faults in portion 67, generator faults in portion 68 and normal conditions in portion 69. Information such as weights 71 and cluster number information 72 may be provided to SOFM module 73 and a fault-cluster number map module 74 in implementation step 76. In step 76, engine data (actual or residuals) may be provided to module 73, which in combination with weights 71, provides cluster number information to the fault-cluster number map module 74. The cluster number information 72 from training step 66 in combination with cluster number information from SOFM module 73 may be put together in module 74 to result in an output of fault diagnosis information.

Multiple wind turbine fault detection may be illustrated with an application in another domain. For instance, a fleet of helicopters operating in Iraq and a fleet of cars in a Midwestern U.S. winter experience analogous operating and environmental conditions. Population statistics for condition indicators across this fleet may indicate normality for that group as well as failures that manifest themselves in those condition indicators. For wind turbines operating in a wind farm and experiencing similar wind patterns and gusts, exploring this population data is a valuable tool. Anomaly detection for an individual wind turbine may classify certain extreme, but normal, operating conditions as faulty. Comparing the performance parameters and condition indicators across a set of wind turbines in the same region will provide insights that prevent raising unnecessary alarms, while confirming actual faults. PCA outputs from a single turbine anomaly detection and performance parameters may be used as inputs to this exercise. In some cases, simple scatter plots and statistical threshold checks may be used as a simple anomaly detector. Alternatively, or in addition, associative models may be used for fault detection in a population of wind turbines.

An associative model (AM) may be used to map system parameters to an identical set of virtual parameters. The AM-based approach can be applied to capture the underlying dynamics of an observable system, such as performance parameters of a set of wind turbines in a wind farm. The residuals between the model output and the input can then be used to detect anomalies and isolate faults. The output of this associative model provides a condition indicator for a specific turbine, which can be compared across the population of turbines experiencing similar environmental conditions.

When applied to the case of sensors data, the AM may capture analytical redundancy among sensors, and may map the readings of a group of correlated sensors into an estimation set of an identical group. When there is an appreciable fault, the associated model estimate may diverge from the actual sensor reading. In some cases, AMs may be implemented as an auto-associative neural network (AANN). It is contemplated that a neural network may be employed as a model of the system that maintains dependencies among parameters of interest. A fault may be considered when there is a break in this overall correlation rather than a deviation in an individual parameter as in a traditional neural network.

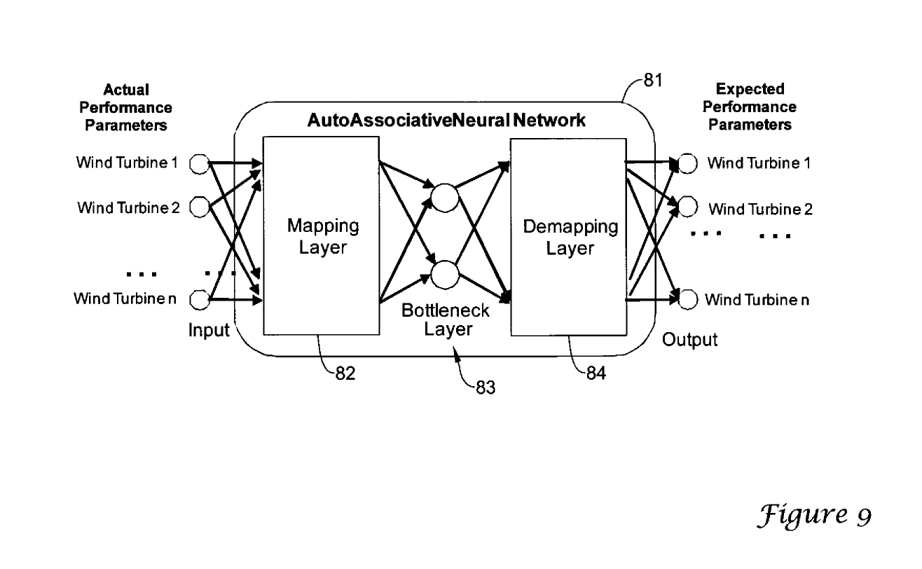

An illustrative wind turbine correlation mapping using AANN for wind turbines is shown in FIG. 9. An auto associative neural network 81 may be applied to wind turbines. Actual performance parameters from wind turbines 1-n may be input to a mapping layer 82 of network 81. Parameter information from layer 82 may go to a bottleneck layer 83. Then information may go from bottleneck layer 83 to a demapping layer 84. Demapping layer 84 may output expected performance parameters for wind turbines 1-n.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

1. A condition-based maintenance system comprising:
an instrument set for connection to one or more wind turbines; and
a performance monitor connected to the instrument set; and
wherein:
the performance monitor is for recording and indicating conditions of the one or more wind turbines; and
the conditions are a basis for determining whether maintenance is recommended for the one or more wind turbines.

2. The system of claim 1, further comprising a wind turbine anomaly detector connected to the instrument set and the performance monitor.

3. The system of claim 2, further comprising a multiple wind turbine anomaly detector connected to the performance monitor and the wind turbine anomaly detector.

4. The system of claim 2, wherein an anomaly detector comprises principal component analysis.

5. The system of claim 2, wherein an anomaly detector comprises a self organizing feature map.

6. The system of claim 3, further comprising an associative model connected to the performance monitor.

7. The system of claim 6, wherein the associative model comprises:
an input for actual wind turbine performance parameters from the instrument set;
a mapping layer connected to the input;
a bottleneck layer connected to the mapping layer;
a demapping layer connected to the bottleneck layer; and
an output, connected to the demapping layer, for providing expected wind turbine performance parameters.

8. The system of claim 3, wherein the instrument set, the wind turbine anomaly detector, the multiple wind turbine anomaly detector and the performance monitor indicate conditions about the one or more wind turbines.

9. The system of claim 8, wherein the instrument set comprises sensors as needed to take measurements at the one or more wind turbines.

10. The system of claim 8, wherein the conditions are classified as normal, anomalous, excessive, deficient, or unclassified, relative to expected conditions.

11. The system of claim 8, wherein the conditions are classified into particular component faults in a specific wind turbine of the one or more wind turbines.

12. The system of claim 10, wherein the conditions as classified result in condition-based maintenance recommendations by a system process of the conditions.

13. The system of claim 12, wherein the system process comprises:
a principal components analysis;
a self organizing feature map approach;
a neural network approach;
a spectral analysis;
an envelope analysis;
pattern matching;
predictive trending;
future projection;
fault diagnosis;
fault prognosis;
a sequential ratio test;
fuzzy logic;
least squares estimation;
partial least squares regression;
data cluster plots; and/or
statistical analysis.

14. A condition-based wind turbine maintenance system comprising:
a first sensor set for connection to a first wind turbine;
a first anomaly detector for connection to the first wind turbine; and
a performance monitor connected to the first sensor set and the first anomaly detector; and
wherein:
the performance monitor is for indicating conditions of the first wind turbine; and
the conditions are a basis for indicating whether maintenance to be recommended for the first wind turbine.

15. The system of claim 14, wherein the conditions are classified into a category relative to expected conditions for the first wind turbine.

16. The system of claim 15, wherein the conditions as classified result in condition-based maintenance recommendations for the first wind turbine.

17. The system of claim 15, further comprising:
a second sensor set for connection to two or more wind turbines;
a second anomaly detector for connection to the two or more wind turbines; and
a second performance monitor connected to the second sensor set and the second anomaly detector.

18. The system of claim 17, wherein the second sensor set, the second performance monitor and the second anomaly detector provide wind turbine population-based parameter sensing and anomaly detection as criteria for classifying conditions of the first wind turbine into a category relative to conditions common to the two or more wind turbines.

19. The system of claim 18, wherein the conditions of the first wind turbine classified into a category relative to expected conditions and the conditions of the first turbine classified into a category relative to conditions common to the two or more wind turbines, are combined to result in conditions for providing condition-based maintenance recommendations for the first wind turbine.

20. A method for providing condition-based maintenance, comprising:
collecting data about one or more wind turbines;
analyzing the data to obtain performance information about the one or more wind turbines;
detecting anomalies, if any, of the one or more wind turbines; and
developing conditions from the performance information and any anomalies of the one or more wind turbines; and
wherein the conditions are a basis for determining whether maintenance is recommended for the one or more wind turbines.

21. The method of claim 20, wherein the data about the one or more turbines comprises measurements as needed at the one or more wind turbines.

22. The method of claim 21, wherein the conditions are classified as normal, anomalous, excessive, deficient, or unclassified, relative to expected conditions of the one or more wind turbines, or their components.

23. The method of claim 22, wherein:
the conditions as classified result in condition-based maintenance recommendations by system processing the conditions; and
system processing comprises:
principal components analysis;
self organizing feature mapping;
neural networking;
spectral analysis;
envelope analysis;
pattern matching;
predictive trending;
future projection;
fault diagnosis;
fault prognosis;
sequential ratio testing;
fuzzy logic;
least squares estimation;
partial least squares regression;
data cluster plotting; and/or
statistical analysis.
